(19) United States
(12) Patent Application Publication
(10) Pub. No.: US 2025/0020844 A1
(43) Pub. Date: Jan. 16, 2025

(54) WIRE GRID POLARIZING ELEMENT, MANUFACTURING METHOD THEREFOR, AND OPTICAL DEVICE

(71) Applicant: Dexerials Corporation, Shimotsuke-Shi (JP)

(72) Inventors: Yusuke Matsuno, Shimotsuke-Shi (JP); Masahiro Oowada, Shimotsuke-Shi (JP)

(73) Assignee: Dexerials Corporation, Shimotsuke-Shi (JP)

(21) Appl. No.: 18/711,537

(22) PCT Filed: Dec. 26, 2022
(86) PCT No.: PCT/JP2022/047852

§ 371 Date: May 17, 2024

(30) Foreign Application Priority Data
Jan. 27, 2022 (JP) 2022-011278

(51) Int. Cl. G02B 5/30

(52) U.S. Cl. CPC G02B 5/3058

(57) ABSTRACT

Provided is a wire grid polarizing element comprising: a transparent substrate; and latticed projections which are arrayed, on one-side surface of the transparent substrate, at a pitch shorter than the wavelength of light in a band to be used and extend in a prescribed direction. The latticed projections each include a reflection layer, a dielectric layer, and an absorption layer in the stated order from the transparent substrate side. The reflection layer contains an AlNd alloy.

### TECHNICAL FIELD

The present invention relates to a wire grid polarizing element, a manufacturing method therefore, and an optical device.

### BACKGROUND ART

A polarizing element is an optical element which absorbs polarized light in a predetermined direction, and transmits polarized light perpendicular to this. In a liquid crystal display device, a polarizing element is required in principle. In particular, in a liquid crystal display device using a light source with a large amount of light such as a transmissive liquid crystal projector, the polarizing element is required to have heat resistance and light stability due to receiving strong radiant rays, and a size on the order of several centimeters, high extinction ratio and control over the reflectance characteristics are required. In order to meet these demands, a wire grid polarizing element has been proposed.

The wire grid polarizing element includes a transparent substrate, and latticed projections which are arranged at a pitch (tens of nanometers to hundreds of nanometers) shorter than the wavelength of light in the usage band on one side of the transparent substrate, and extending in a predetermined direction. Herein, the latticed projections include, in order from a side of the transparent substrate, a reflection layer, a dielectric layer and an absorption layer. When light is incident on this element, the s polarized light (TE wave (s wave)) having an electric field component parallel to the extending direction of the latticed projection cannot permeate, and the p polarized light (TM wave (p wave)) having an electric field component perpendicular to the extending direction of the latticed projection permeates.

The wire grid polarizing element is superior in heat resistance property and light stability, can be fabricated into a relatively large element, and has high extinction ratio. In addition, due to control of the reflectance characteristics also being possible by establishing as a multi-layer structure, and reducing deterioration in image quality by ghosting or the like, occurring by return light reflected by the surface of the element being reflected again into the device, it is suited to a liquid crystal projector.

Accompanying the high luminance of a conventional liquid crystal projector, a high heat resistance property is increasingly required in the wire grid polarizing element. In the wire grid polarizing element, there has been concern over the latticed projections deteriorating, and the polarization property declining under a high temperature environment.

Patent Document 1 discloses the materials constituting the reflection layer using a composite of Al with Au, B, Ce, Cr, Mo, Nb, Nd, Ni, Pt, Sc, Ta, Ti or W.

### CITATION LIST

### Patent Document

Patent Document 1: Japanese Unexamined Patent Application, Publication No. 2021-36315

### DISCLOSURE OF THE INVENTION

### Problems to be Solved by the Invention

However, the heat resistance of a wire grid polarizing element is insufficient.

The present invention has an object of providing a wire grid polarizing element capable of improving the heat resistance.

### Means for Solving the Problems

An aspect of the present invention provides a wire grid polarizing element including a transparent substrate; and latticed projections arranged at a pitch shorter than a wavelength of light of a usage band on one surface of the transparent substrate, and extending in a predetermined direction, in which the latticed projection includes, in order from a side of the transparent substrate, a reflection layer, a dielectric layer and an absorption layer, and in which the reflection layer contains an AlNd alloy.

The AlNd alloy may have Nd content of at least 0.2 at %.

The transparent substrate may be transparent to light of the usage band, and include glass, crystal, quartz or sapphire.

The dielectric layer may include a Si oxide, a Ti oxide, a Zr oxide, an Al oxide, a Nb oxide or a Ta oxide.

The absorption layer may absorb light of the usage band, and contain a metal, alloy or semiconductor.

The above wire grid polarizing element may further include an antireflection layer on another surface of the transparent substrate.

In the above wire grid polarizing element, at least part of a surface may be covered by a protective film. In this case, the protective film may include a material which is the same as the material included in the dielectric layer.

In the above wire grid polarizing element, at least part of a surface may be covered by an organic water-repellent film.

Another aspect of the present invention provides a manufacturing method for a wire grid polarizing element, including the steps of: forming a layered body, by laminating on one surface of a transparent substrate in order from a side of the transparent substrate, a reflection layer, a dielectric layer and an absorption layer; and forming latticed projections arranged at a pitch shorter than a wavelength of light of a usage band, and extending in a predetermined direction, by selectively etching the layered body, in which the reflection layer includes an AlNd alloy.

The AlNd alloy may have a content of Nd of at least 0.2 at %.

The above manufacturing method for a wire grid polarizing element may further include a step of forming an antireflection layer on another surface of the transparent substrate.

The above manufacturing method for a wire grid polarizing element may further include a step a step of covering at least part of the surface by a protective film. In this case, the protective film may include a material which is the same as the material included in the dielectric layer.

The above manufacturing method for a wire grid polarizing element may further include a step a step of covering a step of covering at least part of the surface by an organic water-repellent film.

Another aspect of the present invention provides an optical device which includes the above wire grid polarizing element.

### Effects of the Invention

According to the present invention, it is possible to provide a wire grid polarizing element capable of improving the heat resistance.

### BRIEF DESCRIPTION OF THE DRAWINGS

FIG. 1 is a cross-sectional schematic view showing an example of a wire grid polarizing element according to the present embodiment;

FIG. 2 is a cross-sectional schematic view showing the structure of a test piece according to the Examples;

FIG. 3 provides microphotographs of a surface of a reflection layer before and after conducting a heat-resistance test 1 of the Examples;

FIG. 4 is a graph showing the relationship of a variation amount of n polarized light reflectance of a reflection layer relative to heating time of a heat-resistance test 1 of the Examples;

FIG. 5 is a graph showing the relationship of a change rate of contrast in a wire grid polarizing element relative to heating time of a heat-resistance test 2 of the Examples; and

FIG. 6 is a graph showing the relationship of a change rate of contrast in a wire grid polarizing element relative to heating time of a heat-resistance test 3 of the Examples.

### PREFERRED MODE FOR CARRYING OUT THE INVENTION

Hereinafter, embodiments of the present invention will be explained while referencing the drawings.

### (Wire Grid Polarizing Element)

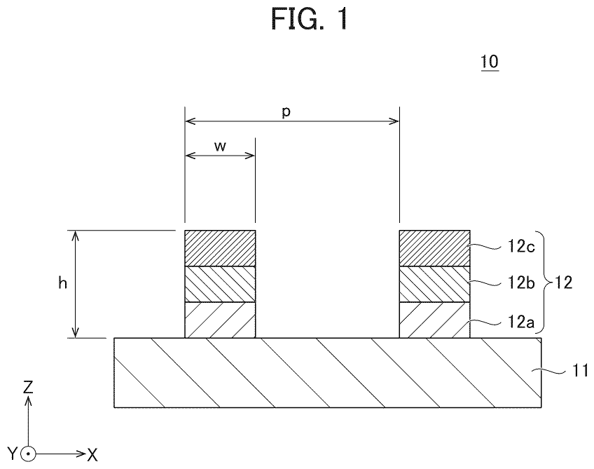

FIG. 1 shows an example of a wire grid polarizing element according to the present embodiment.

The wire grid polarizing element 10 includes: a transparent substrate 11, and latticed projections 12 of width w and height h extending in a Y-axis direction, arranged at a pitch p which is shorter than the wavelength of light in the used band, on one surface of the transparent substrate 11.

Herein, as shown in FIG. 1, the direction in which the latticed projection 12 extends is called the Y-axis direction. In addition, a direction in which the latticed projections 12 are arranged at pitch p along a main surface of the transparent substrate 11, and orthogonal to the Y-axis direction is called the X-axis direction. Furthermore, a direction orthogonal to the Y-axis direction and X-axis direction, and perpendicular to the main surface of the transparent substrate 11 is called the Z-axis direction. It should be noted that light incident on the wire grid polarizing element 10 may be incident from either side of the transparent substrate 11; however, it is preferably incident from the Z-axis direction on a side of the transparent substrate 11 on which the latticed projections 12 are formed (grid surface side).

The wire grid polarizing element 10, by adopting four effects of transmission, reflection, interference and selective light absorption of polarized light by optical anisotropy, attenuates s polarized light (TE wave (s wave)) having an electric field component parallel to the Y-axis direction, and transmits p polarized light (TM wave (p wave)) having an electric field component parallel to the X-axis direction. Therefore, in FIG. 1, the Y-axis direction is the direction of an absorption axis of the wire grid polarizing element 10, and the X-axis direction is a direction of the transmission axis of the wire grid polarizing element 10.

Herein, the height h indicates a dimension in the Z-axis direction perpendicular to the main surface of the transparent substrate 11. In addition, the width w, when viewing the wire grid polarizing element 10 from the Y-axis direction, indicates a dimension in the X-axis direction orthogonal to the height h. Furthermore, the pitch p is a repeating interval in the X-axis direction of the latticed projections 12, when viewing the wire grid polarizing element 10 from the Y-axis direction.

The pitch p is not particularly limited so long as shorter than the wavelength of light in the used band; however, from the viewpoint of ease of manufacture and stability of the wire grid polarizing element 10, for example, it is preferably at least 100 nm and no more than 200 nm. The pitch p can be measured by observing using a scanning electron microscope or a transmission electron microscope. For example, using a scanning electron microscope or a transmission electron microscope, it is possible to measure the pitch p at any four locations, and define the arithmetic mean value thereof as the pitch p. Hereinafter, this measurement method is called electron microscopy.

As shown in FIG. 1, the latticed projection 12 includes, in order from the side of the transparent substrate 11, a reflection layer 12a, dielectric layer 12b and absorption layer 12c. The latticed projections 12 have a wire grid structure arranged in a one-dimensional grid on one surface of the transparent substrate 11.

The light incident from the side of the transparent substrate 11 on which the latticed projections 12 are formed (grid surface side), is partially absorbed and attenuates, upon passing through the absorption layer 12c and dielectric layer 12b. Among the light transmitted through the absorption layer 12c and dielectric layer 12b, the p polarized light (TM wave (p wave)) transmits through the reflection layer 12a with high transmittance. On the other hand, among the light transmitted through the absorption layer 12c and dielectric layer 12b, the s polarized light (TE wave (s wave)) is reflected by the reflection layer 12a. The s polarized light reflected by the reflection layer 12a is partially absorbed upon passing through the dielectric layer 12b and absorption layer 12c; however, part is reflected and returns to the reflection layer 12a. In addition, the s polarized light reflected by the reflection layer 12a interferes and attenuates upon passing through the dielectric layer 12b and absorption layer 12c. In the above way, the grid wire polarizing element 10 can obtain the desired polarization property by the s polarized light being selectively attenuated.

### (Reflection Layer)

The reflection layer 12a is arranged at the pitch p on one surface of the transparent substrate 11, and extends in the Y-axis direction. The reflection layer 12a has a function as a wire grid polarizer, attenuates the s polarized light (TE wave (s wave)) having an electric field component in a direction parallel to the extending direction of the reflection layer 12a, and transmits the p polarized light (TM wave (p wave)) having an electric field component in a direction orthogonal to the extending direction of the reflection layer 12a.

The reflection layer 12a contains an AlNd alloy. The heat resistance property of the wire grid polarizing element 10 thereby improves. As a result thereof, the generation of hillock in the reflection layer 12a under a high-temperature environment is suppressed, and a decline in reflectance and contrast of the reflection layer 12a is suppressed.

In the point of heat resistance property of the wire grid polarizing element 10, the content of Nd in the AlNd alloy is preferably at least 0.2 at %. On the other hand, in the point of reflectance of the reflection layer 12a, the content of Nd in the AlNd alloy is preferably no more than 2.0 at %.

The thickness of the reflection layer 12a is not particularly limited; however, it is preferably at least 100 nm and no more than 300 nm. It should be noted that the measurement method of thickness of the reflection layer 12a is not particularly limited; however, for example, electron microscopy and the like can be exemplified.

The formation method of the reflection layer 12a is not particularly limited; however, for example, a vapor deposition method, sputtering method and the like can be exemplified.

It should be noted that the reflection layer 12a may be a layered body of two or more layers having different compositions of Nd alloy.

### (Dielectric Layer)

The dielectric layer 12b is formed on the reflection layer 12a. In other words, the dielectric layer 12b is arranged at the pitch p, and extends in the Y-axis direction.

The thickness of the dielectric layer 12b is set so as to be a range in which the phase of the s polarized light transmitting through the absorption layer 12c and reflecting by the reflection layer 12a is shifted by half wavelength, relative to the s polarized light reflected by the absorption layer 12c. More specifically, the thickness of the dielectric layer 12b is not particularly limited so long as able to adjust the phase of the s polarized light and enhance interference effect; however, for example, it is appropriately set in a range of at least 1 nm and no more than 500 nm. It should be noted that the measurement method of the thickness of the dielectric layer 12b is not particularly limited; however, for example, electron microscopy and the like can be exemplified.

The material constituting the dielectric layer 12b is not particularly limited; however, for example, Si oxide, Ti oxide, Zr oxide, Al oxide, Nb oxide, Ta oxide or the like can be exemplified.

The refractive index of the dielectric layer 12b is preferably greater than 1.0, and no more than 2.5. The optical properties of the reflection layer 12a are affected by the refractive index of the dielectric layer 12b; therefore, by selecting the material constituting the dielectric layer 12b, it is possible to control the optical properties of the wire grid polarizing element 10. In addition, by appropriately adjusting the thickness and refractive index of the dielectric layer 12b, the s polarized light reflected by the reflection layer 12a, upon penetrating the absorption layer 12c, can be partially reflected and return to the reflection layer 12a, and can attenuate the s polarized light having passed through the absorption layer 12c by interference. By configuring in this way, it is possible to obtain the desired polarization properties by selectively attenuating the s polarized light.

The formation method of the dielectric layer 12b is not particularly limited; however, for example, a vapor deposition method, sputtering method, CVD (Chemical Vapor Deposition) method, ALD (Atomic Layer Deposition) method, and the like can be exemplified.

It should be noted that the dielectric layer 12b may be a layered body of two or more layers having different material constituting.

### (Absorption Layer)

The absorption layer 12c is formed on the dielectric layer 12b. In other words, the absorption layer 12c is arranged at the pitch p, and extends in the Y-axis direction.

The thickness of the absorption layer 12c is not particularly limited; however, for example, it is preferably at least 5 nm and no more than 50 nm. It should be noted that the measurement method for the thickness of the absorption layer 12c is not particularly limited; however, for example, electron microscopy and the like can be exemplified.

The method constituting the absorption layer 12c is not particularly limited so long as material absorbing light of the usage band, i.e. extinction coefficient is not 0; however, metals, alloys, semiconductors, etc. can be exemplified. As the metal, for example, Ta, Al, Ag, Cu, Au, Mo, Cr, Ti, W, Ni, Fe, Sn and the like can be exemplified. As the alloy, for example, an alloy containing at least one type of metal among these metals can be exemplified. In addition, as the semiconductor, for example, Si, Ge, Te, ZnO, silicide materials (β-FeSi₂, MgSi₂, NiSi₂, BaSi₂, CrSi₂, CoSi₂, TaSi, etc.), and the like can be exemplified. In the wire grid polarizing element 10, a high extinction ratio in the visible light range is thereby obtained. Thereamong, the absorption layer 12c preferably contains Fe or Ta, as well as containing Si.

As the material constituting the absorption layer 12c, in the case of using a semiconductor, band gap energy of the semiconductor is involved in light absorption; therefore, it is necessary for the band gap energy of the semiconductor to be no more than the energy of light in the usage band. For example, in the case of the usage band being the visible light range, it is necessary to use a semiconductor which absorbs light having a wavelength of at least 400 nm, i.e. band gap energy no more than 3.1 eV.

The formation method of the absorption layer 12c is not particularly limited; however, for example, a vapor deposition method, sputtering method and the like can be exemplified.

It should be noted that the absorption layer 12c may be a layered body of two or more layers having different constituting materials.

### (Transparent Substrate)

The materials constituting the transparent substrate 11 are not particularly limited so long as being transparent to light of the usage band, and can be appropriately selected according to the purpose.

For the present disclosure and scope of claims, “transparent relative to light of the usage band” does not indicate that the transmittance of light of the usage band is 100%, but rather indicates being a transmittance of light capable of maintaining the function as a polarizing element. For the light of the usage band, for example, visible light having a wavelength of at least 380 nm to no more than 810 nm or the like can be exemplified.

The materials constituting the transparent substrate 11 are not particularly limited; however, for example, materials having a refractive index of at least 1.1 and no more than 2.2 such as glass, crystal, quartz and sapphire can be exemplified. From the viewpoint of cost and light transmittance, quartz and glass are preferable, and quartz (refractive index 1.46) or soda lime glass (refractive index 1.51) are particularly preferable. In addition, from the viewpoint of thermal conductivity, crystal and sapphire are preferable. The heat resistance property of the transparent substrate 11 thereby improves, whereby it is possible to use as a polarizing element for the optical engine of a projector having high heat generation amount.

It should be noted that, as the materials constituting the transparent substrate 11, in the case of using a crystal having optical activity such as crystal and sapphire, it is preferable to arrange the latticed projection 12 in a parallel direction or perpendicular direction relative to the optical axis of the crystal. Superior optical properties are thereby obtained. Herein, optical axis is the directional axis in which the difference in the refractive index between O (ordinary ray) and E (extraordinary ray) of light propagating in this direction becomes the smallest.

The average thickness of the transparent substrate 11 is not particularly limited; however, for example, it is preferably at least 0.3 mm and no more than 1 mm. In addition, the shape of the main surface of the transparent substrate 11 is not particularly limited; however, for example, rectangular or the like can be exemplified.

### (Antireflection Layer)

It should be noted that the wire grid polarizing element 10 may further include an antireflection layer on the other surface of the transparent substrate 11.

The antireflection layer is formed on the transparent substrate 11, and is a multilayer form of two or more layers constituted by the same material as the material constituting the dielectric layer 12b. For example, a low refractive index layer and a high refractive index layer having different refractive indices can attenuate the light interface reflected by forming the antireflection layer laminated alternately.

The thickness of the antireflection layer is not particularly limited; however, for example, it is preferably at least 1 nm and no more than 500 nm. It should be noted that the measurement method for the thickness of the antireflection layer is not particularly limited; however, for example, electron microscopy or the like can be exemplified.

The antireflection layer can be formed as a high-density film by the same method as the dielectric layer 12b; however, from the viewpoint of the density of the antireflection layer, it is desirable to use the IAD method which is ion beam assisted (Ion-beam Assisted Deposition) or IBS method (Ion Beam Sputtering) as the formation method of the antireflection layer.

### (Protective Film)

The wire grid polarizing element 10 may be at least partially covered on the surface by a protective film. Herein, the materials constituting the protective film are the same as the materials constituting the dielectric layer 12b. The durability of the wire grid polarizing element 10 thereby improves.

The formation method of the protective film is not particularly limited; however, for example, the CVD method, ALD method, etc. can be exemplified.

It should be noted that the protective film may be a layered body of two or more layers having different constituting materials, similarly to dielectric layer 12b.

### (Organic Water-Repellent Film)

The wire grid polarizing element 10 may be at least partially covered on a surface by an organic water-repellent film. The moisture resistance of the wire grid polarizing element 10 thereby improves.

The materials constituting the organic water-repellent film are not particularly limited; however, for example, a fluorine-based silane compound such as tridecafluorooctyl trichlorosilane (FOTS) can be exemplified.

The formation method of the organic water-repellent film is not particularly limited; however, for example, the CVD method, ALD method and the like can be exemplified.

### (Manufacturing Method of Wire Grid Polarizing Element)

The manufacturing method of the wire grid polarizing element 10 includes a step of forming a layered body by laminating, in order from the side of the transparent substrate 11 onto one surface of the transparent substrate 11, the reflection layer, dielectric layer and absorption layer; and a step of forming the latticed projections 12 which extend in a predetermined direction, arranged at a pitch shorter than the wavelength of light in the usage band, by selectively etching the layered body.

Upon selectively etching the layered body, first, a one-dimensional lattice-shaped mask pattern is formed on the layered body using a resist by the photolithography method, nanoimprint method or the like. Next, a region of the layered body in which the mask pattern is not formed is etched.

The etching method is not particularly limited; however, for example, a dry etching method using etching gas that reacts with the etching target can be exemplified.

It should be noted that the manufacturing method of the wire grid polarizing element 10 may further include a step of forming an antireflection layer on the other surface of the transparent substrate 11. In addition, the manufacturing method of the wire grid polarizing element 10 may further include a step of covering at least part of the surface with a protective film, and may further include a step of covering at least part of the surface with an organic water-repellent film.

### (Optical Device)

An optical device according to the present embodiment includes the wire grid polarizing element according to the present embodiment.

The optical device according to the present embodiment is not particularly limited; however, for example, a liquid crystal display, a liquid crystal projector, a head-up display, a vehicle headlight and the like can be exemplified. Thereamong, when considering the heat resistance of the wire grid polarizing element according to the present embodiment, a liquid crystal projector is preferable.

In the case of the optical device according to the present embodiment including a plurality of polarizing elements, it is sufficient if at least one of the plurality of polarizing elements is the wire grid polarizing element according to the present embodiment. For example, in the case of the optical device according to the present embodiment being a liquid crystal projector, it is sufficient if at least any of the polarizing elements arranged on the incident side or projection side of the liquid crystal panel is the wire grid polarizing element according to the present embodiment.

Although embodiments of the present invention have been explained above, the present invention is not to be limited to the above embodiments, and the above embodiments may be modified as appropriate within the scope of the gist of the present invention.

### EXAMPLES

Although examples of the present invention have been explained above, the present invention is not to be limited to the examples.

### Experimental Example 1

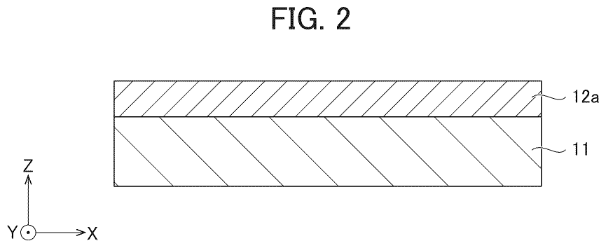

As the transparent substrate 11, a test piece (refer to FIG. 2) imitating the wire grid polarizing element was obtained by forming an AlNd alloy film of 250 nm having a content of Nd of 0.2 at % as the reflection layer 12a on a glass substrate B270 (manufactured by Schott).

### Comparative Experimental Example 1

A test piece was obtained similarly to Experimental Example 1, except for forming an Al film in place of the AlNd alloy film.

### (Heat-Resistance Test 1)

The heat-resistance test 1 was conducted by placing the test piece in an oven heated to 300° C. for 1,000 hours.

### (Microscopy)

Using a microscope, the surface of the reflection layer of the test piece before and after conducting the heat-resistance test 1 was observed.

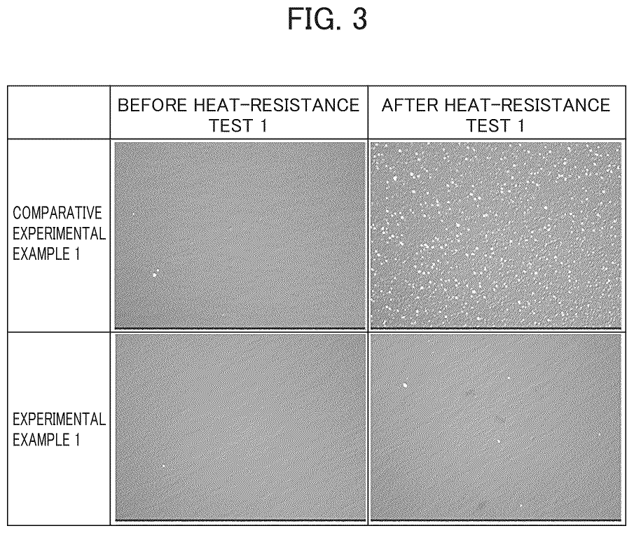

FIG. 3 shows a microphotograph of the surface of the reflection layer before and after conducting the heat-resistance test 1. It is evident from FIG. 3 that the occurrence of hillocks was abundantly found in the Al film of the Comparative Experimental Example 1; whereas, almost no occurrence of hillocks was found in the AlNd alloy film of Experimental Example 1.

### (Variation in n Polarized Reflectance)

In the reflection layer of the test piece when the heating time of the heat-resistance test 1 is a predetermined time, the s polarized light and p polarized light are incident at an incidence angle of 5°, and the n polarized light reflectance is measured using a spectrophotometer. It should be noted that the n polarized light reflectance is the average of the p polarized light reflectance and s polarized light reflectance.

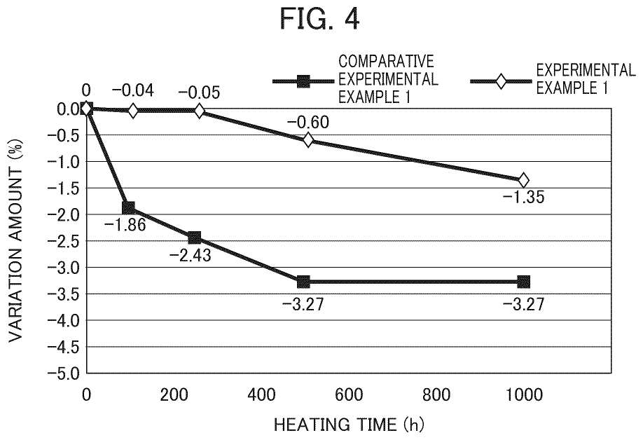

FIG. 4 shows the relationship of the variation amount in n polarized light reflectance of the reflection layer relative to the heating time of the heat-resistance test 1. It is evident from FIG. 4 that the AlNd alloy film of the Experimental Example 1 has the variation in n polarized light reflectance suppressed according to the heat-resistance test 1, compared to the Al film of the Comparative Experimental Example 1.

### Example 1

On one side of the transparent substrate, the latticed projection was formed by laminating the reflection layer, dielectric layer and absorption layer in order from the side of the transparent substrate to form a layered body, and then selectively etching the layered body, thereby obtaining the wire grid polarizing element (refer to FIG. 1). Herein, upon selectively etching the layered body, a one-dimensional latticed mask pattern was formed on the layered body using a resist by way of the photolithography method, and a region of the layered body in which the mask pattern was not formed was etched by a dry etching method. It should be noted that the configuration of the wire grid polarizing element is as follows.
Transparent substrate: glass substrate
Reflection layer: AlNd alloy film having Nd content of 0.2 at % (thickness of 250 nm)
Dielectric layer: SiO₂ film (thickness of 5 nm)
Absorption layer: FeSi film (thickness of 25 nm)
Antireflection layer: multilayer film of SiO₂ film and TiO₂ film
Protective film: SiO₂ film (thickness of 15 nm)
Latticed projection pitch p: 141 nm
Latticed projection width w: 50 nm

### Comparative Example 1

A wire grid polarizing element was obtained similarly to Example 1 except for forming an Al film in place of the AlNd alloy film as the reflection layer.

### (Heat-Resistance Tests 2 and 3)

The heat-resistance test 2 and heat-resistance 3 were respectively conducted by placing the wire grid polarizing element in an oven heated to 300° C. and 350° C. for 1,000 hours.

### (Variation in Contrast (CR))

On the wire grid polarizing element when the heating time of the heat-resistance tests 2 and 3 is a predetermined time, s polarized light and p polarized light were incident at an incidence angle of 5°, and the CR was measured using a spectrophotometer. It should be noted that CR is a ratio of the p polarized light transmittance relative to the s polarized light transmittance.

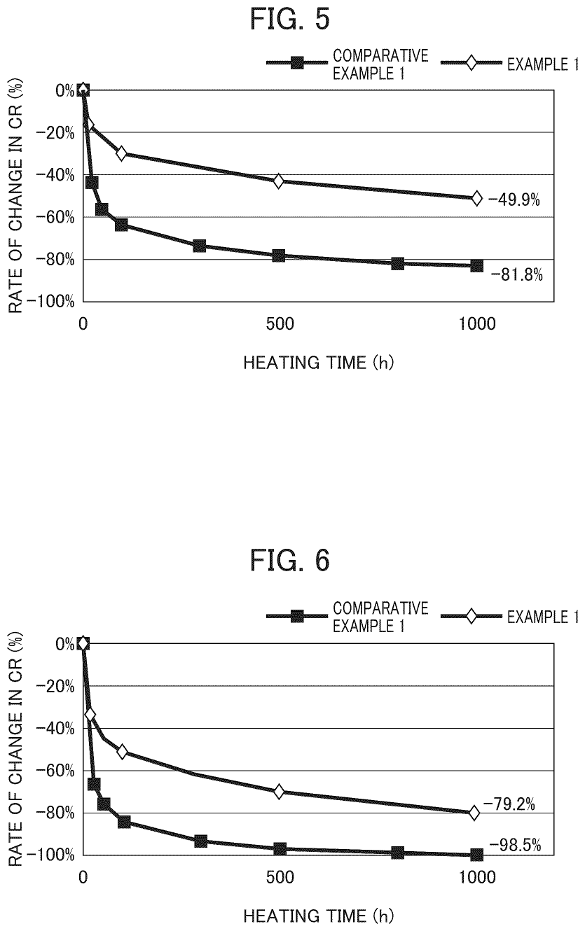

FIG. 5 and FIG. 6 show the relationship of the rate of change in CR of the reflection layer relative to the heating time of the heat resistance tests 2 and 3, respectively. It is evident from FIG. 5 and FIG. 6 that the wire grid polarizing element of Example 1 had a suppressed variation in contrast according to the heat-resistance tests 2 and 3, compared to the wire grid polarizing element of Comparative Example 1.

### EXPLANATION OF REFERENCE NUMERALS

10 wire grid polarizing element
11 transparent substrate
12 latticed projection
12a reflection layer
12b dielectric layer
12c absorption layer

1. A wire grid polarizing element comprising:
a transparent substrate; and
latticed projections arranged at a pitch shorter than a wavelength of light of a usage band on one surface of the transparent substrate, and extending in a predetermined direction,
wherein the latticed projection includes, in order from a side of the transparent substrate, a reflection layer, a dielectric layer and an absorption layer, and
wherein the reflection layer includes an AlNd alloy.

2. The wire grid polarizing element according to claim 1, wherein the AlNd alloy has a content of Nd of at least 0.2 at %.

3. The wire grid polarizing element according to claim 1, wherein the transparent substrate is transparent to light of the usage band, and includes glass, crystal, quartz or sapphire.

4. The wire grid polarizing element according to claim 1, wherein the dielectric layer includes a Si oxide, a Ti oxide, a Zr oxide, an Al oxide, a Nb oxide or a Ta oxide.

5. The wire grid polarizing element according to to claim 1, wherein the absorption layer absorbs light of the usage band, and contains a metal, alloy or semiconductor.

6. The wire grid polarizing element according to claim 1, further comprising an antireflection layer on another surface of the transparent substrate.

7. The wire grid polarizing element according to claim 1,
wherein at least part of a surface is covered by a protective film, and
wherein the protective film includes a material which is the same as the material included in the dielectric layer.

8. The wire grid polarizing element according to claim 1,
wherein at least part of a surface is covered by an organic water-repellent film.

9. A manufacturing method for a wire grid polarizing element, comprising the steps of:
forming a layered body, by laminating on one surface of a transparent substrate in order from a side of the transparent substrate, a reflection layer, a dielectric layer and an absorption layer; and
forming latticed projections arranged at a pitch shorter than a wavelength of light of a usage band, and extending in a predetermined direction, by selectively etching the layered body,
wherein the reflection layer includes an AlNd alloy.

10. The manufacturing method for a wire grid polarizing element according to claim 9, wherein the AlNd alloy has a content of Nd of at least 0.2 at %.

11. The manufacturing method for a wire grid polarizing element according to claim 10, further comprising a step of forming an antireflection layer on another surface of the transparent substrate.

12. The manufacturing method for a wire grid polarizing element according to claim 9, further comprising a step of covering at least part of the surface by a protective film,
wherein the protective film includes a material that is the same as the material contained in the dielectric layer.

13. The manufacturing method for a wire grid polarizing element according to claim 9, further comprising a step of covering at least part of the surface by an organic water-repellent film.

14. An optical device comprising the wire grid polarizing element according to claim 1.
